(19) United States
(12) Patent Application Publication
(10) Pub. No.: US 2025/0000298 A1
(43) Pub. Date: Jan. 2, 2025

(54) Diamond Non-stick Surface and Cooking Utensils

(71) Applicant: One world International Co., Ltd, Taipei (TW)

(72) Inventors: Tien-Yuan Yen, Taipei (TW); SHAO-HSIEN YEN, Taipei (TW)

(21) Appl. No.: 18/668,269

(22) Filed: May 20, 2024

(30) Foreign Application Priority Data
Jun. 29, 2023 (TW) 112124368

(51) Int. Cl. A47J 36/02; C09D 7/61

(52) U.S. Cl. CPC A47J 36/025; C09D 7/61

(57) ABSTRACT

This invention relates to a diamond non-stick surface and cooking utensils featuring such a surface, wherein the diamond non-stick surface includes a metal substrate and a diamond non-stick layer. The diamond non-stick layer, adhered to the metal substrate, comprises a metal bonding layer, multiple euhedral diamond crystals, and a gap filler. The diamond crystals are bonded to the metal substrate via the metal bonding layer. The gap filler, made from a non-stick coating, is disposed in the gaps between adjacent diamond crystals and atop the metal bonding layer, ensuring the combined average thickness of the metal bonding layer and the gap filler is less than the sieving particle size of the diamond crystals. When applied to the food-contact surfaces of cooking utensils, this diamond non-stick surface effectively prevents food from sticking to the spaces between the diamond crystals, significantly enhancing the surface's non-stick performance.

### BACKGROUND OF THE INVENTION

### Field of Invention

The present invention relates to the field of kitchenware technology, specifically to a safer, more reliable, and durable diamond non-stick surface and its application to the surface of cooking utensils.

### Description of Related Art

In the process of kitchen cooking, the oleophilic nature of diamond causes its surface to automatically assume a highly passivated state, exhibiting non-stick characteristics. Diamond has a very high thermal conductivity, which varies with temperature, grain size, crystal form, and chemical composition, but generally ranges from 900 to 2320 W/mK. In comparison, the thermal conductivity of pure copper is only about 400 W/mK. Therefore, when diamond is applied to cooking utensils, its high thermal conductivity can cook ingredients evenly and quickly, saving energy consumption for cooking. The extremely high hardness of diamond renders it extremely resistant to scratching or wear. Moreover, diamond has a very high chemical inertness; it is not affected by any acids or bases at temperature below 500° C. Hence, diamond is undoubtedly the ultimate non-stick coating material for cookware. Chemical Vapor Deposition (CVD) of diamond has been developed for several decades, but it has not been able to achieve large-scale commercial application. The main reason is the poor adhesion of the CVD diamond coating to the substrate and the very high production cost of large-area CVD diamond coatings. On the contrary, about 3500 metric tons of high-pressure, high-temperature (HPHT) synthesized diamonds are consumed globally each year. These are primarily used as super abrasives for cutting and grinding of stone and cement, as well as ultra-precision processing of electronic ceramics and semiconductor wafers. FIG. 1 is a Scanning Electron Microscope (SEM) photo of diamond crystals, synthesized by the HPHT method, showing saw-grade diamond crystals. As shown in the photo, synthetic diamonds usually have a euhedral shape, a cubo-octahedral shape with surfaces composed of smooth facets. The commercially available particle size of HPHT synthesized diamond crystals commonly ranges from 38 μm (400 mesh according to the American National Standards Institute, ANSI, specification) to 1000 μm (18 mesh according to the ANSI specification).

The Scanning Electron Microscope (SEM) photo in FIG. 2 shows the morphology of diamond micro-powder. Diamond micro-powder generally refers to diamond fine powder with a particle size of less than 54 μm. Diamond micro-powder, produced primarily by crushing and grinding low quality HPHT synthesized diamonds, does not have a euhedral shape. It has an irregular shape resembling broken glass with rough surfaces featuring many sharp angles and dimples.

Utilizing mass-produced HPHT synthesized diamonds to create non-stick cookware coatings is a viable method. The U.S. Pat. No. 6,514,605 discloses an implement comprising a substrate and a diamond-tiled layer formed on the substrate. The coating comprises a ceramic binder including porcelain enamel and a plurality of contacting diamond particles bonded to the ceramic binder to provide an exposed diamond-tiled surface. At least 40% of the exposed surface of the implement is diamond, and the diamond particles have a maximum dimension less than or equal to 50 μm and greater than 0.01p m.

The diamond-tiled surface described in the aforementioned patent document has the following drawbacks:

First, distributing diamond particles on a substrate surface inevitably results in gaps between the particles. If the material filling these gaps lacks non-stick properties, cooking ingredients are prone to sticking. In the diamond-tiled surface described in the patent document, about 50% of the exposed surface is made of porcelain enamel materials, significantly reducing the non-stick capabilities of the diamond-tiled surface.

Second, the diamond particles used in the patent document are diamond micro-powders. As shown in FIG. 2, the rough and irregularly shaped surfaces of diamond micro-powders increase the likelihood of mechanical interlocking with food, thereby reducing the non-stick efficacy.

Third, the use of porcelain enamel materials as the binder for diamond particles in the patent document has encountered many problems. Due to the brittleness of porcelain enamel materials and their weak bonding with diamonds, they easily fracture under mechanical stress, causing bonded diamond particles to fall off.

Therefore, the existing diamond-tiled surfaces, with their anti-adhesion and non-stick properties, still need to be improved. The bonding of diamond particles to the substrate also needs to be improved. How to solve the above problems has become the subject of improvement for the present invention.

### BRIEF SUMMARY OF THE INVENTION

The objective of the present invention is to provide a diamond non-stick surface with excellent non-stick properties and superior bond between the diamond and the substrate.

Another objective of the present invention is to provide cooking utensils whose food-contact surfaces incorporate the diamond non-stick surface of the present invention.

The technical solution involves a diamond non-stick surface comprising a metal substrate and a diamond non-stick layer. The diamond non-stick layer, adhered to the metal substrate, includes a metal bonding layer, diamond crystals with euhedral shapes, and a gap filler with a non-stick coating. The diamond crystals are bonded to the metal substrate via the metal bonding layer. The gap filler is applied in gaps between adjacent diamond crystals and on the metal bonding layer, ensuring the sum of the first average thickness of the metal bonding layer and the second average thickness of the gap filler is less than the sieving particle size of the diamond crystals.

Furthermore, the euhedral shape of the diamond crystals is a cubo-octahedral shape.

Moreover, the metal bonding layer is bonded to the diamond crystals by brazing.

Furthermore, the particle size of the diamond crystals is 230/270 mesh to 20/25 mesh according to the ANSI mesh size, and the sieving particle size is 53 μm to 710 μm.

Furthermore, the first average thickness of the metal bonding layer, defined as the average thickness at a point intermediate between adjacent diamond crystals, is 20 μm to 500 μm;

The second average thickness of the gap filler, defined as the average thickness at a point intermediate between adjacent diamond crystals, is 12 μm to 150 μm.

Moreover, the particle size of the diamond crystals is 170/200 mesh to 25/30 mesh according to the ANSI mesh size, and the sieving particle size is 75 μm to 600 μm.

Moreover, the first average thickness of the metal bonding layer, defined as the average thickness at a point intermediate between adjacent diamond crystals, is 25 μm to 420 μm; the second average thickness of the gap filler, defined as the average thickness at a point intermediate between adjacent diamond crystals, is 20 μm to 120 μm.

Furthermore, the metal bonding layer contains 5 wt % to 26 wt % chromium; the metal substrate is stainless steel.

Furthermore, the metal bonding layer contains 1.5 wt % to 20 wt % titanium.

Moreover, the non-stick coating of the gap filler is selected from fluorocarbon resin coatings, silicone resin coatings, and sol-gel ceramic coatings.

Another aspect of the present invention relates to cooking utensils, wherein the food-contact surface of the cooking utensils has the diamond non-stick surface according to the invention.

Consequently, the technical solutions provided by the present invention can achieve the following advantageous effects:

First, by filling the gaps between diamond crystals with a gap filler having non-stick properties, it prevents food from sticking to the spaces between diamond crystals, significantly enhancing the non-stick performance of the diamond non-stick surface.

Second, the invention uses cubo-octahedral diamond crystals with smooth facets, effectively reducing the mechanical interlocking with food, thus markedly improving the non-stick capabilities of the diamond crystals.

Third, the metal bonding layer of the present invention, which includes chromium or titanium in the active brazing alloy, can react with the surface of the diamond crystals to form metal carbides and provide metallurgical joining with the metal substrate, greatly improving the bonding of the diamond to the metal substrate. Even under extremely high mechanical stress, efficient diamond crystal retention will be achieved.

### BRIEF DESCRIPTION OF THE DRAWINGS

FIG. 1 is a Scanning Electron Microscope (SEM) image showing saw-grade diamond crystals.

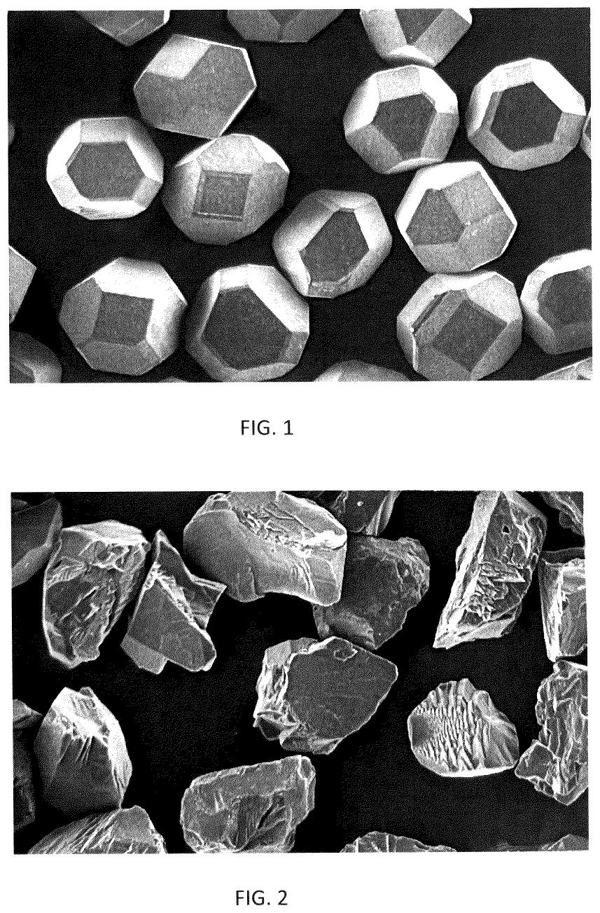

FIG. 2 is a Scanning Electron Microscope (SEM) image showing diamond micro-powder.

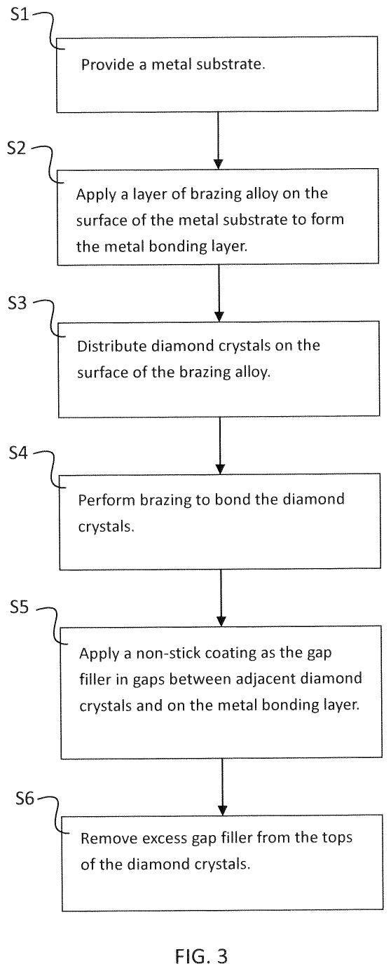

FIG. 3 is a flowchart describing the method of forming a diamond non-stick surface according to the present invention.

FIG. 4a through 4f are sectional views of a diamond non-stick surface at various stages of the process described in FIG. 3.

FIG. 5 is a schematic illustration of a cooking utensil incorporating a diamond non-stick surface of the present invention.

### DETAILED DESCRIPTION OF THE EMBODIMENTS

The present invention is described in a clear and comprehensive manner through the embodiments in conjunction with the accompanying drawings. It is evident that the embodiments described herein represent merely a part of the embodiments of the invention, rather than all embodiments. All other embodiments obtained by those of ordinary skill in the art, based on the embodiments of the invention, without making creative efforts, fall within the scope of protection of the present invention.

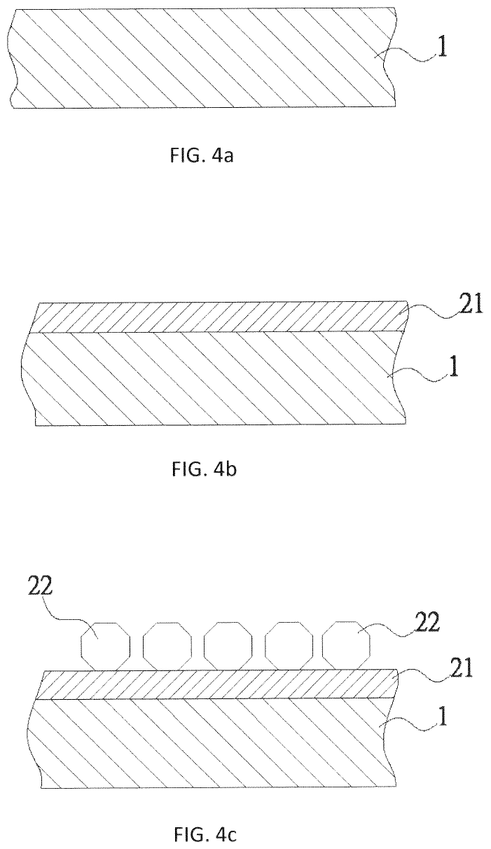

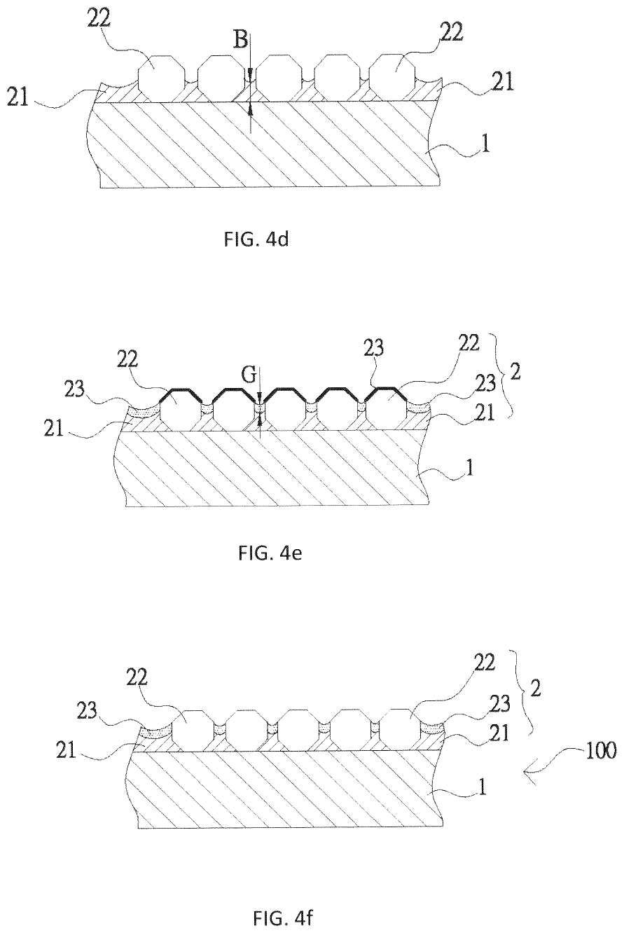

As shown in FIG. 3 and FIG. 4, the drawings depict a diamond non-stick surface. The diamond non-stick surface 100 comprises a metal substrate 1 and a diamond non-stick layer 2; the diamond non-stick layer 2 is adhered to the metal substrate 1 and includes a metal bonding layer 21, multiple diamond crystals 22, and a gap filler 23. The diamond crystals 22 are bonded to the metal substrate 1 via the metal bonding layer 21, and the diamond crystals 22 have a euhedral shape. The gap filler 23, made from a non-stick coating, is disposed in the gaps between adjacent diamond crystals 22 and atop the metal bonding layer 21; the sum of the first average thickness B of the metal bonding layer 21 and the second average thickness G of the gap filler 23 is less than the sieving particle size D_{S} of the diamond crystals 22.

Referring to FIG. 3 and FIG. 4a, in step S1, a metal substrate 1 is provided. The metal substrate 1 of the present invention can be chosen from carbon steel, stainless steel, cast iron, copper, copper alloys, titanium, and titanium alloys. Preferred are carbon steel and stainless steel. In step S1, if necessary, the surface of the metal substrate 1 may be subjected to a surface-roughening treatment, which can be performed by any method; examples include chemical etching with acid or alkali, mechanical polishing, and sandblasting.

Referring to FIG. 3 and FIG. 4b, in step S2, a layer of brazing alloy is placed on the surface of the metal substrate 1 to form the metal bonding layer 21. The method of placement can be determined based on the form of the brazing alloy used. Examples of forms include foil, powder, and wire. A foil-shaped brazing alloy, after being cut into any shape, may be temporarily fixed on the surface of the metal substrate 1 with an adhesive. A powder form of brazing alloy is preferred, which can be combined with an organic adhesive and solvent to create a flexible pad, paste, or brazing paint. The flexible pad can be easily processed into any required shape and then temporarily fixed on the surface of the metal substrate 1 with an adhesive. The paste may be applied to the surface of the metal substrate 1 using either screen printing or brushing. Brazing paint may be applied to the surface of the metal substrate 1 by means of spraying, screen printing, or brushing. Preferably, the brazing paint is applied by spraying.

In step S2, the metal bonding layer 21 can be prepared by active brazing alloys containing strong carbide-forming elements such as chromium (Cr), niobium (Nb), tantalum (Ta), vanadium (V), titanium (Ti), and zirconium (Zr). Preferably, these alloys contain chromium (Cr) or titanium (Ti). The metal bonding layer 21 prepared from active brazing alloys can react with the carbon on the surface of the diamond crystals 22, forming strong chemical bonds and creating very stable carbides such as chromium carbide (Cr₃C₂, Cr₇C₃), niobium carbide (NbC), tantalum carbide (TaC), vanadium carbide (V₄C₃), titanium carbide (TiC) and zirconium carbide (ZrC). Hence, active brazing alloys can achieve strong bonding to the diamond crystals 22 and metallurgical joining with the metal substrate 1, providing a more secure bond.

Preferably, chromium-containing brazing alloys used for the metal bonding layer 21 of the present invention include, but are not limited to, the compositions of the commercial chromium-containing brazing alloys listed in Table 1.

TABLE 1

| Abbreviation | | Brazing |
|---|---|---|
| or product | | temperature |
| name | Composition (wt %) | (° C.) |
| BNi-2 | (Bal.) Ni- (6-8) Cr- | 1010~1177 |
| | (2.75-3.50) B- (4-5) | |
| | Si- (2.5-3.5) | |
| BNi-7 | Fe (Bal.) Ni- (13-15) | 927~1093 |
| | Cr- (9.7-10.5) P | |
| BNi-12 | (Bal.) Ni- (24-26) | 980~1095 |
| | Cr- (9-11) P | |
| NicrobrazLM | (Bal.) Ni -(7) Cr- (3) | 1010~1170 |
| | Fe- (4.5) Si- (3) B | |

Advantageously, the composition of the metal bonding layer 21 used in the present invention preferably comprises 5 wt % to 26 wt % chromium (Cr), and the corresponding metal substrate 1 is preferably stainless steel.

Preferably, titanium (Ti)-containing brazing alloys used for the metal bonding layer 21 of the present invention include, but are not limited to, the compositions of commercial titanium-containing brazing alloys listed in Table 2.

TABLE 2

| Abbreviation | | Brazing |
|---|---|---|
| or product | | temperature |
| name | Composition (wt %) | (° C.) |
| Cusil ABA | (Bal.) Ag- (35.2) Cu- (1.75) Ti | 830~850 |
| Ticusil | (Bal.) Ag- (26.7) Cu- (4.5) Ti | 920~960 |
| AgCuTi | (Bal.) Cu- (68.7-70.7) Ag- | 830~930 |
| | (2.0-5.0) Ti | |
| BrazeTec | (Bal.) Ag- (25.2) Cu- (10) Ti | 850~950 |
| CB10 | | |
| CuSnTi | (Bal.) Cu- (18-20) Sn- (9-11) Ti | 880~930 |
| TiBraze | (Bal.) Cu- (19-21) Sn- (17-19) | 890~920 |
| 900V | Ti- (1-3) V | |

Advantageously, the composition of the metal bonding layer 21 used in the present invention preferably comprises 1.5 wt % to 20 wt % of titanium (Ti), and the corresponding metal substrate 1 is not particularly limited. Examples thereof include carbon steel, stainless steel, cast iron, copper, copper alloy, titanium, and titanium alloy.

Referring to FIGS. 3 and 4c, in step S3, the diamond crystals 22 are distributed on the surface of the brazing alloy used to form the metal bonding layer 21. The method of distributing the diamond crystals 22 is not particularly limited, and any appropriate method can be used. Methods such as uniform sieving through a mesh or using a stencil, screen, or other templates to distribute the diamond crystals 22 in any desired pattern are options. For ease of operation, an adhesive, such as a pressure-sensitive adhesive, can be used to temporarily position the diamond crystals 22 on the surface of the brazing alloy used to form the metal bonding layer 21.

Advantageously, the diamond crystals 22 used in the present invention have a euhedral shape. Usually, diamond crystallizes in a shape that is intermediate between a cube and an octahedron. The morphology of HPHT synthesized diamonds is typically bonded by cubic and octahedral facets, forming various cubo-octahedral crystal shapes. Advantageously, the diamond crystals 22 used in the present invention can particularly be of cubo-octahedral shape.

Commercially, the particle size grading of HPHT synthesized diamonds is generally performed by sieving. Advantageously, the particle size of the diamond crystals 22 in the present invention can be mesh sizes, according to the ANSI specification, from 230/270 mesh to 20/25 mesh, for example, 230/270 mesh, 200/230 mesh, 170/200 mesh, 140/170 mesh, 120/140 mesh, 100/120 mesh, 80/100 mesh, 70/80 mesh, 60/70 mesh, 50/60 mesh, 45/50 mesh, 40/45 mesh, 35/40 mesh, 30/35 mesh, 25/30 mesh, and 20/25 mesh. Advantageously, the preferred particle size of the diamond crystals 22 used in the present invention is mesh sizes, according to ANSI specification, from 170/200 mesh to 25/30 mesh, for example, 170/200 mesh, 140/170 mesh, 120/140 mesh, 100/120 mesh, 80/100 mesh, 70/80 mesh, 60/70 mesh, 50/60 mesh, 45/50 mesh, 40/45 mesh, 35/40 mesh, 30/35 mesh, and 25/30 mesh. In the present invention, there is no particular upper limit to the particle size of the diamond crystals 22, but the cost of larger mesh diamonds, such as greater than 20 mesh, may be too expensive to be commercially viable. On the other hand, diamond crystals 22 with smaller mesh size, such as less than 270 mesh, tend to be more irregular shape, and the non-stick performance will be poor.

In accordance with the present invention, the sieving particle size D_{S} of the diamond crystals 22 is equal to the width of the square hole of the lower sieve in micrometers (μm). For instance, the sieving particle size D_{S} for diamond crystals 22 of 230/270 mesh is the width of the square hole of the 270 mesh sieve, which means the sieving particle size D_{S} for the diamond crystals 22 of 230/270 mesh is 53 μm. Preferably, a sieving particle size D_{S}, for the diamond crystals 22 used in the present invention can range from 53 μm to 710 μm, for example, 53 μm, 63 μm, 75 μm, 90 μm, 106 μm, 125 μm, 150 μm, 180 μm, 212 μm, 250 μm, 300 μm, 355 μm, 425 μm, 500 μm, 600 μm, and 710 μm. Advantageously, a sieving particle size D_{S} for the diamond crystals 22 used in the present invention can more preferentially range from 75 μm to 600 μm, for example, 75 μm, 90 μm, 106 μm, 125 μm, 150 μm, 180 μm, 212 μm, 250 μm, 300 μm, 355 μm, 425 μm, 500 μm, and 600 μm.

Referring to FIGS. 3 and 4d, in step S4, the diamond crystals 22 are brazed onto the surface of the metal substrate 1. Typically, the assembled combination of the metal substrate 1, the brazing alloy, and the diamond crystals 22 has undergone a heating process at the elevated temperature needed for brazing. To prevent the graphitization of diamonds during the high-temperature brazing process, as well as to avoid oxidation of the brazing alloy and the metal substrate 1, the selection of the heating atmosphere is crucial. The heating method for brazing can be selected from a reducing atmosphere furnace, an inert gas atmosphere furnace, and a vacuum furnace. Preferably, brazing is conducted in a vacuum furnace, with vacuum pressure from about 0.1 Pa to about 0.000 Pa. The optimal brazing temperature is usually slightly higher than the liquidus temperature of the brazing alloy to promote the flowing and wetting of the brazing alloy on the diamond crystals and metal substrate 1. The brazing temperature for various brazing alloy compositions can be seen from Table 1 and Table 2. Regarding the heating cycle of the vacuum furnace brazing, those skilled in the relevant field can select appropriate values depending on actual requirements.

FIG. 4d shows that diamond crystals 22 are bonded to the metal substrate 1 after the brazing process. During the fusion of the brazing alloy, the bottom and side surfaces of diamond crystals 22 are wetted by the alloy, forming a unique wetting configuration. The metal bonding layer 21 is characterized as having a concave surface, i.e., the metal bonding layer 21 thickness is at a minimum at a point intermediate between adjacent diamond crystals 22. In the present invention, the thickness of the metal bonding layer 21 is defined as the thickness of the metal bonding layer 21 at a point intermediate between adjacent diamond crystals 22, and the first average thickness B of the metal bonding layer 21 is the average thickness of the metal bonding layer 21 at a point intermediate between adjacent diamond crystals 22. The thickness of the metal bonding layer 21 can be measured by analysis of the microscopic images in cross-sectional observations under an optical microscope or a scanning electron microscope (SEM). According to the present invention, the metal bonding layer 21 thickness measurement is performed at 20 random points on the cross-section of the diamond non-stick surface 100. The first average thickness B of the metal bonding layer 21 is obtained by averaging these 20 measurements.

Due to the good wetting of the brazing alloy to the diamond crystals, the brazing alloy clings well to the diamond surface and forms a unique wetting configuration. Thus, greater surface contact between the diamond and the brazing alloy is achieved to provide a very secure bond. Therefore, the required thickness of the metal bonding layer 21 in the present invention can be about 0.2 to about 0.7 times the sieving particle size D_{S} of the diamond, to provide a secure bond of the diamond crystals 22 to the metal substrate 1. Advantageously, the first average thickness B of the metal bonding layer 21 in the present invention can be 20 μm to 500 μm, for example, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, 155 μm, 160 μm, 165 μm, 170 μm, 175 μm, 180 μm, 185 μm, 190 μm, 195 μm, 200 μm, 210 μm, 220 μm, 230 μm, 240 μm, 250 μm, 260 μm, 270 μm, 280 μm, 290 μm, 300 μm, 310 μm, 320 μm, 330 μm, 340 μm, 350 μm, 360 μm, 370 μm, 380 μm, 390 μm, 400 μm, 410 μm, 420 μm, 430 μm, 440 μm, 450 μm, 460 μm, 470 μm, 480 μm, 490 μm, and 500 μm. More advantageously, the preferred first average thickness B of the metal bonding layer 21 in the present invention is 25 μm to 420 μm, for example, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, 155 μm, 160 μm, 165 μm, 170 μm, 175 μm, 180 μm, 185 μm, 190 μm, 195 μm, 200 μm, 210 μm, 220 μm, 230 μm, 240 μm, 250 μm, 260 μm, 270 μm, 280 μm, 290 μm, 300 μm, 310 μm, 320 μm, 330 μm, 340 μm, 350 μm, 360 μm, 370 μm, 380 μm, 390 μm, 400 μm, 410 μm, and 420 μm. If the thickness of the metal bonding layer 21 is too large, the brazing alloy may flow over the surface of diamond crystals 22, covering them with a metal layer; if the thickness of the metal bonding layer 21 is too small, the bonding of the diamond crystals 22 may be poor.

Referring to FIGS. 3 and 4e, in step S5, the gap filler 23 is applied in gaps between adjacent diamond crystals 22 and on the metal bonding layer 21. The gap filler 23 is made from a non-stick coating. Advantageously, the non-stick coating used as a gap filler 23 in the present invention can be chosen from the group comprising fluorocarbon resin coatings, silicone resin coatings, and sol-gel ceramic coatings. Advantageously, the fluorocarbon resin coating for the present invention is a conventional non-stick coating, and preference is given to using polytetrafluoroethylene (PTFE), perfluoroalkoxy (PFA), fluorinated ethylene propylene (FEP), and their mixtures. Preferably, the fluorocarbon resin coating may also contain reinforcing fillers and/or pigments. The composition of the fluorocarbon resin coating is not critical, and a variety of fluorocarbon resin coating compositions conventionally used in the formation of a non-stick coating can be employed as a gap filler 23 in the present invention. Furthermore, the fluorocarbon resin coating preferably includes a multi-layer coating structure, such as a primer layer and at least one topcoat. More preferably, the fluorocarbon resin coating may contain one or more heat-resistant bonding resins, such as polyamide-imide resin (PAI), polyimide (PI), polyethersulfone (PES), polyphenylene sulfide (PPS), and polyetheretherketone (PEEK).

Advantageously, the silicone resin coating applied in the present invention is a conventional non-stick silicone resin coating. Preferably, the silicone resin coating may also contain pigments and/or fillers, such as carbon black, graphite, titanium dioxide (TiO₂), iron oxide (Fe₂O₃, Fe₃O₄), silicon dioxide (SiO₂), aluminum oxide (Al₂O₃), aluminum powder, glass powder, mica, calcium carbonate (CaCO₃), and silicon carbide (SiC). The composition of the silicone resin coating is not critical, and a variety of silicone resin coating compositions conventionally used in the formation of a non-stick coating can be employed as a gap filler 23 in the present invention.

Advantageously, the sol-gel ceramic coating applied in the present invention is a conventional non-stick sol-gel ceramic coating. Preferably, the sol-gel ceramic coating for the present invention is any non-stick sol-gel ceramic coating containing silicon (Si). Furthermore, the sol-gel ceramic coating may also contain pigments and/or fillers, such as titanium dioxide (TiO₂), iron oxide (Fe₂O₃, Fe₃O₄), mica, silicon dioxide (SiO₂), aluminum oxide (Al₂O₃), and silicon carbide (SiC). The composition of the sol-gel ceramic coating is not critical, and a variety of sol-gel ceramic coating compositions conventionally used in the formation of a non-stick coating can be employed as a gap filler 23 in the present invention.

The gap filler 23 may be applied by various conventional coating methods. Examples of the method include spraying, brushing, roll coating, curtain-flow coating, and spin coating. Spraying is preferred. After application of the gap filler 23, a non-stick coating, it may be dried and baked to form a dry layer adhered to the metal bonding layer 21. The drying and baking temperatures and times will vary depending on the composition and the thickness of the gap filler 23. Those skilled in the art of non-stick coating processing are aware of the necessary drying and baking temperatures and times for various compositions and thicknesses of the gap filler 23.

As shown in FIG. 4e, the baked surface of the gap filler 23 between adjacent diamond crystals 22 features a concave surface, i.e., the gap filler 23 thickness is at a minimum at a point intermediate between adjacent diamond crystals 22.

In the present invention, the thickness of the gap filler 23 is defined as the thickness of the gap filler 23 at a point intermediate between adjacent diamond crystals 22, and the second average thickness G of the gap filler 23 is the average thickness of the gap filler 23 at a point intermediate between adjacent diamond crystals 22.

The thickness of gap filler 23 can be measured by analysis of the microscopic images in cross-sectional observations under an optical microscope or a scanning electron microscope (SEM). According to the present invention, the gap filler 23 thickness measurement is performed at 20 random points on the cross-section of the diamond non-stick surface 100. The second average thickness G of the gap filler 23 is obtained by averaging these 20 measurements.

Advantageously, the second average thickness G of the gap filler 23 in the present invention can be 12 μm to 150 μm, for example, 12 μm, 14 μm, 16 μm, 18 μm, 20 μm, 22 μm, 24 μm, 26 μm, 28 μm, 30 μm, 32 μm, 34 μm, 36 μm, 38 μm, 40 μm, 42 μm, 44 μm, 46 μm, 48 μm, 50 μm, 52 μm, 54 μm, 56 μm, 58 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, and 150 μm. More advantageously, the preferred second average thickness G of gap filler 23 in the present invention is 20 μm to 120 μm, for example, 20 μm, 22 μm, 24 μm, 26 μm, 28 μm, 30 μm, 32 μm, 34 μm, 36 μm, 38 μm, 40 μm, 42 μm, 44 μm, 46 μm, 48 μm, 50 μm, 52 μm, 54 μm, 56 μm, 58 μm, 60 μm, 65 μm, 70 μm, 75 μm, 80 μm, 85 μm, 90 μm, 95 μm, 100 μm, 105 μm, 110 μm, 115 μm, and 120 μm. If the thickness of the gap filler 23 is too large, it may cover the diamond surfaces; if the thickness of the gap filler is too small, the non-stick capability may be insufficient.

Advantageously, in the present invention, the sum of the first average thickness B of the metal bonding layer 21 and the second average thickness G of the gap filler 23 is less than the sieving particle size D_{S} of the diamond crystals 22. This design ensures that the concave surface of the gap filler 23 is lower than the adjacent diamond crystals 22. Crucially, the combined average thickness of the metal bonding layer 21 and gap filler 23 is less than the sieving particle size of the diamond crystals 22. When the diamond non-stick surface 100 of the present invention is scratched or encountered abrasive force during cooking or cleaning, only the peaks of diamond crystals 22 are exposed to the mechanical stress. The gap filler 23 residing in the gaps and depressions between diamond crystals 22 remains protected by the diamond crystals 22 and free from damage and abrasive wear.

As can be seen from FIG. 4e, during application of the gap filler 23, there is excess gap filler 23 deposited on the tops of diamond crystals 22. In step S6, the excess gap filler 23 on the tops of diamond crystals 22 is removed by any known method such as brushing, wiping, scrubbing with abrasive pad, mechanical grinding, and polishing. As shown in FIG. 4f, the tops of diamond crystals 22 have been cleaned, revealing bright facets. Advantageously, the diamond crystals 22 used in the present invention are of cubo-octahedral shape, characterized by smooth facets with low surface roughness. Furthermore, the cubo-octahedral shaped diamonds tend to have better food release properties, owing to their good roundness reducing the likelihood of mechanical interlocking with food.

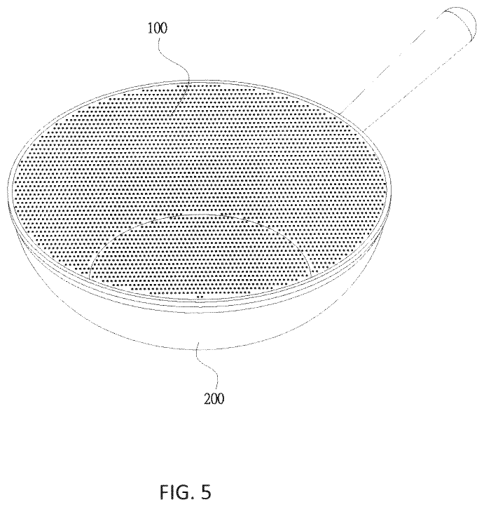

FIG. 5 is a schematic illustration of a cooking utensil 200 incorporating a diamond non-stick surface 100 of the present invention. Examples of the cooking utensil 200 include frying pans, skillets, sauté pans, woks, grill pans, griddles, pancake pans, barbecue grills, baking pans, sauce pans, Dutch ovens, braising pans, pots, and caquelons. Additionally, the cooking utensil 200 commonly includes at least one handle fixed on the outer surface.

### EXAMPLES

In the following examples and comparative examples, the method for estimating the first average thickness B of the metal bonding layer and the second average thickness G of the gap filler involves cross-sectional SEM analysis. On the cross-section of the diamond non-stick surface, the thickness of the metal bonding layer at the midpoint between 20 diamond crystals is measured. The average of these measurements defines the first average thickness B. Similarly, the thickness of the gap filler at the midpoint between 20 diamond crystals is measured and averaged to determine the second average thickness G.

### Example 1

An 8-inch stainless steel baking pan, commercially available, serves as the metal substrate. The inner surface is first degreased using acetone. It is then sandblasted to create a rough surface, washed with water, and dried using hot air.

For the metal bonding layer, BNi-2 brazing alloy is chosen. This alloy consists of 6-8 wt % chromium, 2.75-3.50 wt % boron, 4-5 wt % silicon, 2.5-3.5 wt % iron, and the remainder is nickel. The alloy is a powder with a particle size of under 325 mesh.

A brazing paint is prepared by mixing the brazing alloy powder with water-based acrylic resin and deionized water. This paint is then evenly sprayed onto the pan's inner surface using a gravity spray gun with a 0.5 mm nozzle, at 0.25 MPa air pressure. The coated surface is dried at 80° C. for 15 minutes. The thickness of the sprayed layer is controlled to adjust the first average thickness of the metal bonding layer.

Synthetic diamond crystals, model HSD90 from Huanghe Whirlwind Co., are chosen for their 20/25 mesh size (according to ANSI standards) and cubo-octahedral shape. A pressure-sensitive adhesive, FB49 by 3M Co., is brush-applied over the dried brazing paint. Diamond crystals are then densely sprinkled onto the adhesive layer.

The pan undergoes high vacuum brazing in a vacuum furnace set at approximately 0.01 Pa. The brazing temperature is maintained at 1010° C. for 10 minutes, followed by cooling inside the furnace. For the gap filler, fluorocarbon resin coating, including black primer 420G-703 and PFA topcoat 858G-210 (both from Chemous Co.), is applied. This is done using a gravity spray gun with a 0.5 mm nozzle at 0.2 MPa air pressure. The primer is dried at 220° C. for 10 minutes, the topcoat at 150° C. for 10 minutes, and then the assembly is baked in an air oven at 400° C. for 15 minutes.

After achieving the desired second average thickness of the gap filler, the diamond crystals' surfaces are polished in water using a Scotch-Brite 96S-5M pad (by 3M Co.) to remove any excess coating and reveal the diamonds' bright facets.

The measurements for the first average thickness of the metal bonding layer and the second average thickness of the gap filler are detailed in Table 3.

### Examples 2 and 3

Following the same methodology as Example 1, an 8-inch stainless steel baking pan is employed as the metal substrate. For Example 2, synthetic diamond model HWD92 from Huanghe Whirlwind Co., with a 40/45 mesh size according to ANSI, is used. In Example 3, the chosen synthetic diamond is model SDB 1100 from Element Six Co., with a 25/30 mesh size according to ANSI. The resulting diamond non-stick surfaces' layer thicknesses are as outlined in Table 3.

### Example 4

A commercially available 8-inch carbon steel frying pan is utilized as the metal substrate, undergoing the same surface preparation steps as outlined in Example 1. This involves degreasing, sandblasting, washing, and drying processes to ready the surface for the application of the metal bonding layer.

The chosen material for the metal bonding layer in this embodiment is a CuSnTi brazing alloy. This alloy comprises 9-11 wt % titanium, 18-20 wt % tin, and the balance copper, with a particle size of under 300 mesh.

A brazing paint, created by adding water-based acrylic resin and deionized water to the brazing alloy powder, is sprayed onto the pan's surface using a gravity spray gun. The nozzle diameter is set to 0.5 mm, with a spray pressure of 0.25 MPa, and the coating is dried at 80° C. for 15 minutes. This process controls the thickness of the metal bonding layer.

For the diamond component, synthetic diamonds of the HFD-D model, sourced from Huanghe Whirlwind Co. and meeting ANSI's 120/140 mesh size criteria, are selected for their cubo-octahedral shape. These diamonds are affixed to the prepared surface using a layer of pressure-sensitive adhesive FB49 by 3M Co., applied over the dried brazing paint.

The assembly is then subjected to high vacuum brazing in a vacuum furnace at approximately 0.01 Pa, with a brazing temperature of 920° C. and a holding time of 20 minutes before being cooled within the furnace. The application method for the gap filler, a fluorocarbon resin coating, mirrors that described in Example 1.

### Example 5

Adopting the same base material and preparation techniques as Example 1, an 8-inch stainless steel baking pan serves as the substrate. This embodiment differentiates itself through the use of synthetic diamond model HWD-92 from Huanghe Whirlwind Co., which complies with ANSI's specifications for a 45/50 mesh size.

The gap filler in this case is a silicone resin coating, model PAOFLON9666-161 produced by Baokun Chemical Co., incorporating carbon black and aluminum powder pigments for enhanced performance. The coating process involves the use of a gravity spray gun, as previously described, with a nozzle diameter of 0.5 mm and a spray pressure of 0.2 MPa. Following the application, the coating is dried in hot air at 150° C. for 10 minutes and then baked at 280° C. for 15 minutes to achieve the desired thickness and properties.

### Example 6 to 8

Leveraging the same carbon steel frying pan and preparation method as Example 4, these examples explore the effects of using different synthetic diamond models and sizes. Example 6 incorporates synthetic diamond model HFD-D by Huanghe Whirlwind Co., with a particle size of 140/170 mesh according to ANSI standards. Example 7 uses the same diamond model but with a 100/120 mesh size, and Example 8 employs the PDA999 model from Element Six Co., featuring an 80/90 mesh size.

The gap filler applied in these examples is identical to the silicone resin coating described in Example 5, ensuring consistency in the evaluation of the non-stick properties across different diamond sizes and shapes.

### Example 9

This embodiment also utilizes an 8-inch carbon steel frying pan prepared according to the method established in Example 4. The diamond component is the synthetic diamond model PDA999 from Element Six Co., with a finer particle size of 170/200 mesh, following ANSI standards. The selected gap filler is a sol-gel ceramic coating, model NC-9168-4711 by Baokun Chemical Co. This non-stick ceramic coating contains silica sol, applied with the same technique and care as detailed in previous examples, ensuring a consistent and high-quality non-stick surface.

### Example 10

Following the methodology established in Example 1, an 8-inch stainless steel baking pan, readily available in the market, is employed as the metal substrate. The surface preparation and bonding processes are replicated here for consistency.

In this embodiment, synthetic diamond model HFD-D from Huanghe Whirlwind Co., characterized by an ANSI particle size of 230/270 mesh, is chosen for its specific granular properties. The gap filler technique mirrors that of Example 9, employing a sol-gel ceramic coating to achieve the non-stick qualities desired.

The measurements for the first average thickness of the metal bonding layer and the second average thickness of the gap filler, crucial for assessing the non-stick performance, are compiled in Table 3 for reference.

### Comparative Examples 1 to 3

To contextualize the performance of the examples, comparative examples were developed using an 8-inch stainless steel baking pan as the metal substrate, following the preparatory steps outlined in Example 1. However, these examples diverge by excluding the application of a gap filler, leaving the spaces between the diamond crystals unfilled.

Comparative Example 1 employs synthetic diamond model PDA446 by Element Six Co., with an ANSI mesh size of 170/200, exploring the effect of different crystal shape on non-stick performance without a gap filler.

Comparative Example 2 uses synthetic diamond model SDB1100, also by Element Six Co., with a mesh size of 35/40.

Comparative Example 3 utilizes synthetic diamond model PDA999 from Element Six Co., with a mesh size of 80/90, further varying the diamond sizes for comparative analysis.

### Comparative Examples 4 and 5

Similar to the approach taken in examples 1 to 3, these comparative examples employ an 8-inch carbon steel frying pan, prepared according to Example 4, but omit the gap filler in the non-stick surface creation.

Comparative Example 4 examines the use of synthetic diamond model W3.5 from Yuefe Diamond Co., with an approximate ANSI mesh size of 6000, pushing the boundaries of particle fineness.

Comparative Example 5 reverts to the synthetic diamond model HFD-D by Huanghe Whirlwind Co., with a mesh size of 230/270, to assess the impact of gap filler omission on non-stick performance across a spectrum of particle sizes.

Non-stick Test:

To objectively evaluate the non-stick capabilities of both examples and comparative examples, a standardized test was conducted. An electric hot plate heated each pan to 150° C., with surface temperatures verified by a contact thermocouple thermometer. Without the addition of cooking oil, approximately 50 ml of egg liquid was cooked for 2 minutes on the pan surface.

Non-stick performance was quantified using a 5-point scale based on the ease of egg removal:
5 points: Complete removal of the egg without residue.
4 points: Near-complete removal, with minimal residue not exceeding 1 cm².
3 points: Moderate sticking, with residue spanning 3 to 4 cm².
2 points: Significant egg adherence, with about 50% of the egg remaining.
1 point: Extensive sticking, with over 75% of the egg adhered to the pan.

The detailed outcomes of this testing protocol are compiled in Table 3, demonstrating the superior non-stick performance of the examples over the comparative examples.

TABLE 3

| | Particle | | | | | | | |
|---|---|---|---|---|---|---|---|---|
| | Size of | | | | | | | |
| | Diamond | Sieving | | | First | | Second | |
| | (ANSI | Particle | Diamond | Metal | Average | | Average | |
| | Mesh | Size (Dₛ, | Crystal | Bonding | Thickness | | Thickness | Non-Stick |
| Example | Size) | μm) | Shape | Layer | (B, μm) | Gap Filler | (G, μm) | Grade |
| Example 1 | 20/25 | 710 | cubo- | BNi-2 | 500 | fluorocarbon | 150 | 5 |
| | | | octahedral | | | resin | | |
| Example 2 | 40/45 | 355 | cubo- | BNi-2 | 240 | fluorocarbon | 80 | 5 |
| | | | octahedral | | | resin | | |
| Example 3 | 35/40 | 600 | cubo- | BNi-2 | 420 | fluorocarbon | 120 | 5 |
| | | | octahedral | | | resin | | |
| Example 4 | 120/140 | 106 | cubo- | CuSnTi | 40 | fluorocarbon | 42 | 5 |
| | | | octahedral | | | resin | | |
| Example 5 | 45/50 | 300 | cubo- | BNi-2 | 200 | silicone | 54 | 5 |
| | | | octahedral | | | resin | | |
| Example 6 | 140/170 | 90 | cubo- | CuSnTi | 35 | silicone | 30 | 5 |
| | | | octahedral | | | resin | | |
| Example 7 | 100/120 | 125 | cubo- | CuSnTi | 50 | silicone | 46 | 5 |
| | | | octahedral | | | resin | | |
| Example 8 | 80/90 | 150 | cubo- | CuSnTi | 90 | silicone | 38 | 5 |
| | | | octahedral | | | resin | | |
| Example 9 | 170/200 | 75 | cubo- | CuSnTi | 25 | sol-gel | 20 | 5 |
| | | | octahedral | | | ceramic | | |
| Example 10 | 230/270 | 53 | cubo- | BNi-2 | 20 | sol-gel | 12 | 4 |
| | | | octahedral | | | ceramic | | |
| Comparative | 170/200 | 75 | irregular | BNi-2 | — | — | — | 1 |
| Example 1 | | | | | | | | |
| Comparative | 35/40 | 600 | cubo- | BNi-2 | — | — | — | 1 |
| Example 2 | | | octahedron | | | | | |
| Comparative | 80/90 | 150 | cubo- | BNi-2 | — | — | — | 1 |
| Example 3 | | | octahedron | | | | | |
| Comparative | 6000 | 2-4 | irregular | CuSnTi | — | — | — | 1 |
| Example 4 | | | | | | | | |
| Comparative | 230/270 | 53 | cubo- | CuSnTi | — | — | — | 1 |
| Example 5 | | | octahedral | | | | | |

The testing results unequivocally showcase the enhanced non-stick efficacy of the diamond non-stick surfaces developed in Examples 1 through 10, as compared to the performance in Comparative Examples 1 through 5. This evidences the significant advantage of incorporating gap fillers alongside diamond crystals in the creation of high-performance non-stick cooking surfaces.

It is important to recognize that the scope of the present invention is not confined to the detailed embodiments described herein. Variations and modifications conceivable by those skilled in the art fall within the purview of this invention. This could involve combining or altering the technical elements presented in the described embodiments to create new configurations, all of which should be considered within the ambit of the present invention. The claims that follow, and their legal equivalents, therefore, define the intended scope of protection.

I claim:

1. A diamond non-stick surface, comprising:
a metal substrate (1); and
a diamond non-stick layer (2) adhered to the metal substrate (1), the diamond non-stick layer (2) comprising:
a metal bonding layer (21);
a plurality of diamond crystals (22) bonded to the metal substrate (1) via the metal bonding layer (21), the diamond crystals (22) having an euhedral shape; and
a gap filler (23) made from a non-stick coating, disposed in the gaps between adjacent diamond crystals (22), and atop the metal bonding layer (21);
wherein the sum of a first average thickness (B) of the metal bonding layer (21) and a second average thickness (G) of the gap filler (23) is less than a sieving particle size of the diamond crystals (22).

2. The diamond non-stick surface according to claim 1, wherein the euhedral crystal shape of the diamond crystals (22) is cubo-octahedral.

3. The diamond non-stick surface according to claim 2, wherein the metal bonding layer (21) is bonded to the diamond crystals (22) by brazing.

4. The diamond non-stick surface according to claim 3, wherein the particle size of the diamond crystals (22) is 230/270 mesh to 20/25 mesh according to the American National Standards Institute (ANSI) mesh size, and the sieving particle size of the diamond crystals (22) is 53 μm to 710 μm.

5. The diamond non-stick surface according to claim 4, wherein
the first average thickness (B) of the metal bonding layer (21), defined as the average thickness at a point intermediate between adjacent diamond crystals (22), is 20 μm to 500 μm; and
the second average thickness (G) of the gap filler (23), defined as the average thickness at a point intermediate between adjacent diamond crystals (22), is 12 μm to 150 μm.

6. The diamond non-stick surface according to claim 5, wherein
the metal bonding layer (21) comprises 5 wt % to 26 wt % of chromium; and
the metal substrate (1) is stainless steel.

7. The diamond non-slick surface according to claim 6, wherein the non-stick coating of the gap filler (23) is one of a fluorocarbon resin coating, a silicone resin coating, and a sol-gel ceramic coating.

8. The diamond non-stick surface according to claim 5, wherein the metal bonding layer (21) comprises 1.5 wt % to 20 wt % of titanium.

9. The diamond non-stick surface of claim 8, wherein the non-stick coating of the gap filler (23) is one of a fluorocarbon resin coating, a silicone resin coating, and a sol-gel ceramic coating.

10. A cooking utensil (200),
the food-contact surface of which has a diamond non-stick surface (100) according to claim 1.
